(19) United States
(12) Patent Application Publication
(10) Pub. No.: US 2006/0068758 A1
(43) Pub. Date: Mar. 30, 2006

(54) Securing local and intra-platform links

(76) Inventors: Abhay Dharmadhikari, Beaverton, OR (US); Mrudula Yelamanchi, Portland, OR (US); Jane Dashevsky, Beaverton, OR (US); Benjamin Matasar, Portland, OR (US); Selim Aissi, Beaverton, OR (US); Jose Puthenkulam, Beaverton, OR (US); Shelagh Ann Callahan, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 10/957,273

(22) Filed: Sep. 30, 2004

(51) Int. Cl. H04M 1/66

(52) U.S. Cl. 455/411

(57) ABSTRACT

A method of securing a local link may involve exchange of initiation messages and negotiation of ciphersuites across a local link. The method then transmits a server authentication and receives a client authentication. Upon validation of the server and client authentication, information from the cipher is used to encrypt communications across the local link. In addition, there is a method of providing intra-platform security. The method performs authentication between two endpoints on a platform and then generates keys between the two endpoints to form a trusted tunnel. The keys are used to encrypt communications between the endpoints.

### BACKGROUND

Security in communications has become a high priority in many arenas. Wireless communication use has increased dramatically and these communications have a higher vulnerability to interception and attack. Security has also increased to protect this vulnerability and has focused mostly on issues external to the communications platform. The communications platform may be a computer, personal digital assistant (PDA), cellular phone and many others. The layers of security provided tend to handle issues at the network level, securing connection to the network as well as transmissions to, from and across the network. Very little attention has been paid to local links, defined here as links between devices.

In addition, as the use of electronics communication has increased, sensitive information may be vulnerable to attack within the platform. For example, many notebook computers use a wireless local area network (WLAN) card for communications. When this computer is used to perform authentication into a cellular network, the unprotected environment may allow a relatively inexpensive attack on sensitive authentication data. This risk increases with the increasing popularity of personal computers, most of which share almost all information about themselves.

### BRIEF DESCRIPTION OF THE DRAWINGS

Embodiments of invention may be best understood by reading the disclosure with reference to the drawings, wherein:

FIG. 1 shows an embodiment of two devices communicating via a local link.

FIG. 2 shows an embodiment of a message flow diagram of messages between two devices communicating on a protected local link.

FIG. 3 shows a flowchart of an embodiment of a method to secure a local link.

FIG. 4 shows a block diagram of an embodiment of a device having a secure local link communications capability.

FIGS. 5a-b show different views of an example of a device vulnerable to an intra-platform attack.

FIG. 6 shows a block diagram of a sample device having intra-platform security.

FIG. 7 shows a flowchart of an embodiment of a method to provide intra-platform security.

### DETAILED DESCRIPTION OF THE EMBODIMENTS

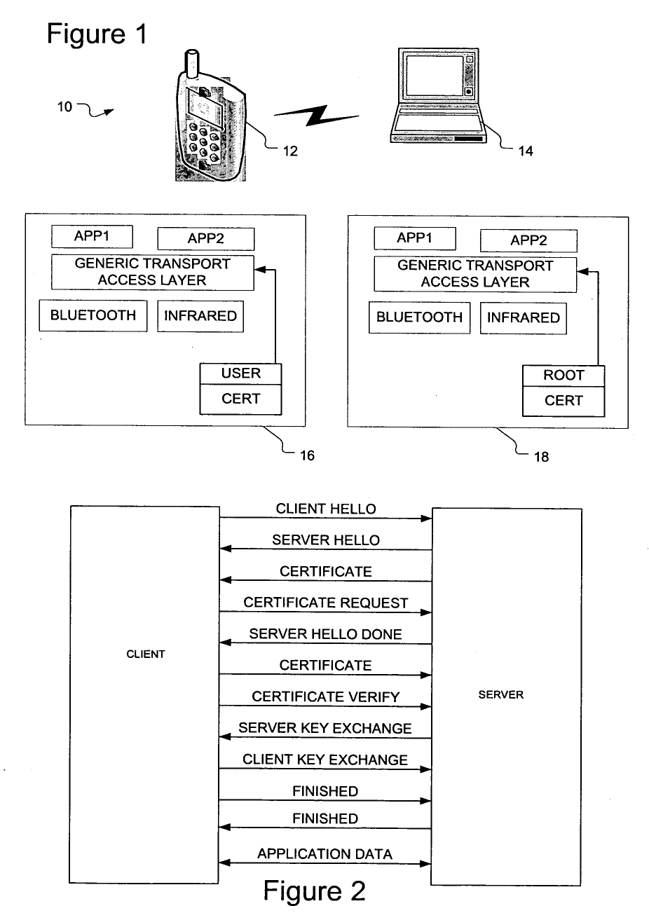

FIG. 1 shows an embodiment of a system using a local link. The devices shown in the system 10 are a personal digital assistant 12 and a personal computer 14 communicating via a local link. As defined here, a local link is one that is just a connection between two, or possibly more, devices. The local link does not establish a network, nor provide any connection to a network infrastructure.

For example, a personal digital assistant (PDA) may use a local link to synchronize with a personal computer. If the personal computer is also connected to a wider network, the link is only local if the personal digital assistant does not use the personal computer to access the network. This local link could also be wireless

Two popular communication methods used primarily for local links are Bluetooth® and IrDA (Infrared Data Association). Bluetooth is a wireless radio standard for a fast-acknowledging, frequency-hopping, short distance radio connection in the ISM (Industrial, Scientific and Medical), unlicensed band of 2.4 Gigahertz (GHz).

An IrDA link is a link based upon infrared signals similar to those used on remote controls for televisions. The IrDA specification includes the necessary requirements for devices to communicate via infrared pulses. These are line-of-sight connections, and generally are effective up to 10-15 feet.

A major concern in these types of local links is security. Bluetooth is criticized due to flaws in its security, and the IrDA specification does not consider security. It is possible to deploy Transport Layer Security (TLS) based protocols to provide a trusted tunnel between the two devices using the local link. Transport Layer Security is set out in the Internet Engineering Task Force (IETF) Request for Comments 2246. A trusted tunnel, as defined here, is a connection between two devices that are known and authenticated to each other.

The TLS protocol is designed as a successor to the Secured Socket Layer (SSL) protocol that is widely in use. TLS is designed to be application independent and based upon a handshaking protocol in which the two devices exchange information that could be validated by either side. The application independence provides developers and system designers the ability to specify the particulars of the handshake process.

Embodiments of this invention define a general transport access layer (GTA) that is independent of the devices that use the local link. It is based upon the TLS and assumes that both end points of the tunnel are in a relatively secure location and that they both have security authentication capability. The GTA provides mutual authentication and establishes an encrypted, integrity-protected tunnel for data communications between devices on the local link.

Referring back to FIG. 1, the two devices are defined as a client and server. To be a server, the device merely has to have the ability to perform processing and communication, as well as store authentication information. The terms ‘server’ and ‘client’ are merely used to differentiate between the initiating device, the ‘server,’ and the responding device, the ‘client.’ In the example discussed below, the Personal Digital Assistant (PDA) is assumed to be the client and the computer to be the server, but it could also be reversed. A server could also be a cellular phone or any device that has the necessary processing and communications capabilities. Examples of a client are a computer, a PDA, a cellular phone, a printer, a digital camera, or any other device capable of performing a handshake. Some computer peripherals such as printers and cameras may not have the necessary capacity to act as a server but could be clients.

In the example of FIG. 1, the client is provisioned with authentication information, which may be a certificate issued by a certificate authority, as shown in 16. It also has to have the root authentication, such as root certificate of the server's certificate authority. The server must have the root authentication, such as the root certificate of the personal digital assistant's certificate authority, as shown in 18. The authentication information is provisioned on both platforms prior to the current interaction.

As can be seen in FIG. 1, the certificate is used by the GTA to secure the link regardless of the nature of the link. The same certificate and process would be used for the client and the server, regardless if the communication link is Bluetooth, IrDA or any other local link communication. As mentioned above, the GTA ‘hides’ the specifics of the handshake used to establish the secure tunnel from the application. It is transparent to the method of transport as well as the applications using the communications link.

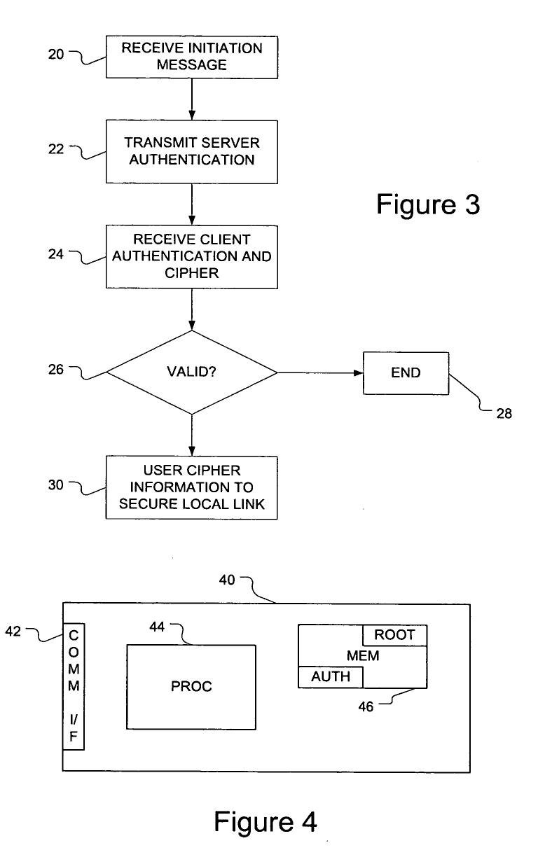

One embodiment of a messaging process to perform the handshake is shown in FIG. 2. This may be best understood when used in conjunction with the flowchart of FIG. 3. The process of FIG. 2 assumes the use of certificates, but may use other types of authentication, as is set out in FIG. 3. The client transmits a “Client Hello” message to the server, which receives it as an initiation message at 20 in FIG. 3.

The server responds with the server certificate or other server authentication credentials at 22 in FIG. 3. After validating the server's root certificate, the client responds with the client/user certificate and a ciphersuite. The server receives the client authentication and ciphersuite at 24 in FIG. 3. The ciphersuite or ciphersuite information may generally constitute a set of supported cryptographic algorithms. This information will generally include an encryption algorithm and cryptographic keys. After the server validates the client certificate, shown at 26 in FIG. 3, it agrees to the cipher selection. Other forms of authentications credentials than individual certificates may include shared secrets and other types of credentials.

In order to create the trusted tunnel, it is generally advisable that the keys be generated using platform tokens. A platform token is a unique identifier of that particular platform, such as a cell phone or notebook computer. One option would be to use a Trusted Platform Module. A Trusted Platform Module is a hardware component that implements the Trusted Computing Group specification for enhancing the security of the computing environment across multiple platforms and devices. Another option is to use the Media Access Control (MAC) address, which is a unique address for each node of a network. While a network is not being deployed in this particular communication link, most devices will have a unique identifier if one were to use a MAC address. Once the keys have been exchanged and the encryption cipher suite agreed upon, future data sent between the two devices is encrypted at 30 of FIG. 3. This forms a trusted tunnel between the two devices for the communication link. If the validation process at 26 fails, the communication ends at 28.

FIG. 4 shows an embodiment of a server device 40 capable of establishing a trusted tunnel with a client device across a local link. A port 42 allows the device to communicate over a local link. A memory 46 stores a server authentication and a root authentication for at least one client. A processor 44 receives a communication through the port, wherein the communication includes a certificate from a client device. The processor then authenticates the client device, and transmits the server authentication to the client device. As mentioned above the port may be any local link.

Embodiments of the invention may be implemented by providing instructions contained on an article of machine-readable media. The instructions, when executed by the machine such as the server, would cause the server to implement the methods of the invention.

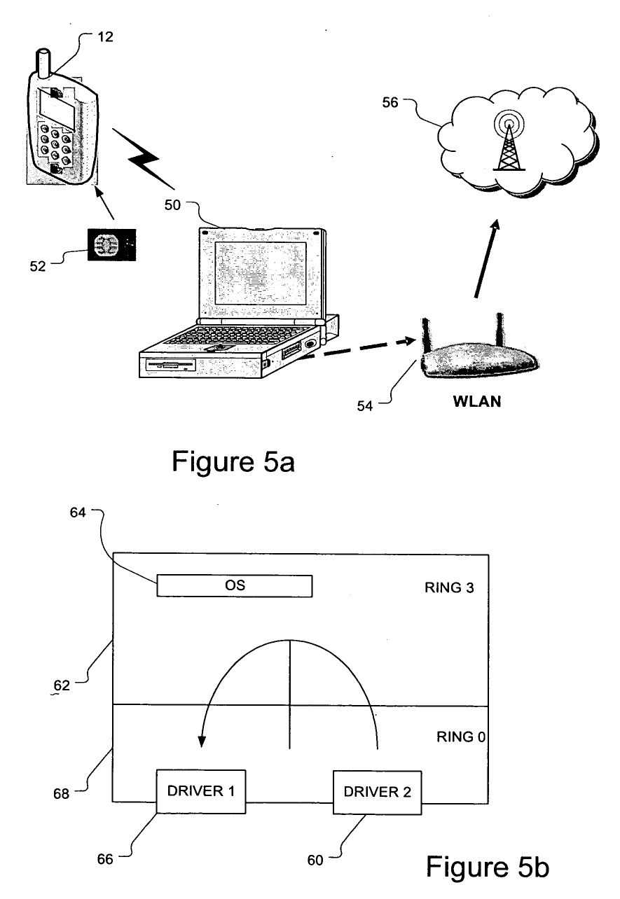

In addition to addressing the problems with data being transmitted across local links external to the devices, there is also some vulnerability for data internal to a device. FIGS. 5a and 5b show an example of a device that may have some intra-platform security vulnerability. Intraplatform is used here to refer to communication paths that are internal to a particular platform, such as a notebook PC or a cellular phone. This may be in addition to local link security, such as between the device 50 and the cellular phone 12, or the intraplatform paths alone.

The device 50, in this example a notebook computer, is used to transmit information from a SIM (subscriber identity module) card 52 in cell phone 12 through a wireless access point (WAP) 54 to a network 56. It must be noted that the SIM card is representative of many different kinds of smart cards and the scope of the invention is not limited to SIM cards. The network may be a network compliant with the GSM (Global System for Mobile communications). Assuming the information is encrypted as it leaves the notebook to the WAP and the network, vulnerability remains as data is transferred from the SIM card on a communications port of the computer to the wireless port. Malicious software residing in the notebook may capture this information and transmit it across the network to third parties such as identity thieves.

FIG. 5b shows a block diagram representation of an operating system generally in accordance with the Windows® operating system of Microsoft® Corporation. It must be noted that analogous structures to those discussed with regard to Windows exist on just about any operating system, and the scope of the invention is not limited to Windows operating systems.

In FIG. 5b, the SIM card would be on a communications port having a driver 60 in the kernel layer of the operating system, sometimes referred to in Windows as Ring 0, 68. The data is then passed from the driver through the Ring 3/application mode, 62 of the operating system 64 where most of its functionality resides and, further, to the application running in Ring 3. The operating system 64 then passes the information to driver 66 for the second communications device, such as the Wireless Local Area Network (WLAN) card. During the period of time in which the information is in Ring 3, it is vulnerable to attack. The information could be attacked during the time it is in Ring 0, but kernel attacks require much more sophisticated knowledge and technology, so are generally more expensive compared to Ring 3 attacks.

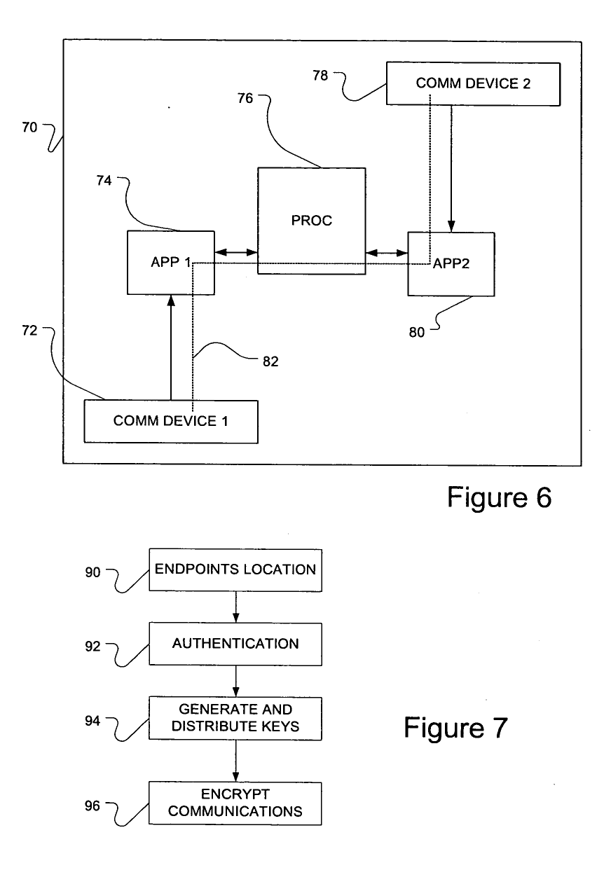

Using a similar approach to the GTA for local links, it is possible to provide a system that uses a trusted tunnel between the two endpoints internal to the system. The endpoints may be drivers, such as Ring 0 drivers, or may be the peripheral hardware components, such as communication module connected to the system. As can be seen in FIG. 6, the device 70 has a trusted tunnel 82 between the two endpoints, communication endpoint 1, 72 and communication endpoint 2, 78. The applications 74 and 80 use encrypted communications when being operated upon by the processor 76. The applications are generally instructions located in memory that are executed by the processor. The processor may reside in the device 70, or could be processor located on either one of the communication endpoints.

The trusted tunnel may be established using the GTA above, one implementation of which is the Transport Layer Security protocol, or the Secured Sockets Layer protocol. An embodiment of a method to establish the trusted tunnel of FIG. 6 is shown in flowchart form in FIG. 7. The endpoints of the tunnel are located at 90. The processor of the system desiring the secure tunnel would locate the endpoints of the tunnel desired. Alternatively, the two endpoints may discover each other. The initiating communication device, such as the one that is connected to the SIM card 52 in FIG. 5a, and the responding communication device would perform the authentication process of exchanging and validating each other's authentication information at 92.

Once authentication is complete, the two endpoints generate and distribute keys at 94. The keys are then used in encrypting communications between the endpoints at 96.

Another consideration is at which point the processor will locate the endpoints. As discussed above, it is desirable the tunnel begins and ends below Ring 0, or kernel, mode to raise the difficulty level of attacking the data. A location below Ring, 0 or kernel mode, may be inside the firmware or hardware of the communication devices. This results in data that is to be transmitted by the communication devices being encrypted before it is exposed to the main system memory. In this manner, data would be secure inside the platform for the majority of the areas of risk.

It is possible that the system could implement the methods of the invention by receiving instructions from an article of machine-readable media. The instructions, when executed, would cause the machine, in this case the device 50 or 70 as examples, to implement the methods of the invention.

Thus, although there has been described to this point a particular embodiment for a method and apparatus for securing data communications across local links and intra-platform, it is not intended that such specific references be considered as limitations upon the scope of this invention except in-so-far as set forth in the following claims.

What is claimed is:

1. A method of securing a local link, comprising:
receiving an initiation message;
negotiating a ciphersuite across the local link;
transmitting server authentication credentials;
receiving client authentication credentials;
validating the client authentication credentials;
generating an encryption key based upon the cipher; and
encrypting any further communications across the local link using the encryption key.

2. The method of claim 1, transmitting a server authentication credentials further comprising:
transmitting one from the group comprised of: a certificate, a shared secret, and other credential.

3. The method of claim 1, wherein receiving a client authentication further comprising:
receiving one from the group comprised of: a certificate, a shared secret, and other credential.

4. The method of claim 1, negotiating a cipher further comprising negotiating on ciphersuite information containing cryptographic key types.

5. The method of claim 1, generating a key further comprising generating a key from one of the group comprised of: a platform token, a trusted platform module, a platform identity, and a network media access control address.

6. A device, comprising:
an interface allowing the device to communicate over a local link;
a memory to store a server authentication credentials and root authentication credentials for at least one client;
a processor to:
receive a communication through the port, wherein the communication includes client authentication credentials;
verify client authentication credentials; and
transmit the server authentication credentials to the client device.

7. The device of claim 6, the interface further comprising one selected from the group comprised of: a Bluetooth communication interface, an IrDA interface, and a wireless communication interface.

8. The device of claim 6, the memory to store a server authentication credentials and a root authentication credentials further comprising a memory to store a server certificate and a root certificate.

9. The device of claim 6, the network device further comprising one selected of the group comprised of: a computer, a personal digital assistant, a cellular phone, and other client device.

10. A system comprising:
a server device having server authentication credentials;
a client device having client authentication credentials; and
a local communication link between the server device and the client device,
wherein communications across the link are secured by the server and client authentication credentials and data encryption.

11. The system of claim 10, the server further comprising one selected from the group comprising a PC, a notebook computer, a personal digital assistant, cellular phone, and other client device.

12. The system of claim 10, the client further comprising one selected from the group comprised of: a notebook computer, a personal digital assistant, a cellular phone, a printer, and other client device.

13. The system of claim 10, the local link further comprising one of the group comprised of: radio communications, IrDA, Bluetooth and other wireless communications.

14. A method of providing intra-platform security, comprising:
performing authentication between two endpoints on a platform;
generating keys on the two endpoints; and
using the keys to encrypt communications between the endpoints.

15. The method of claim 14, performing authentication further comprising exchanging and validating certificates between the two endpoints.

16. The method of claim 14, generating keys further comprising keys based upon platform tokens.

17. The method of claim 14 comprising selecting endpoints from the group comprised of: in the kernel of the operating system, in the firmware below the kernel of the operating system, and inside communication modules in the platform.

18. A system, comprising:
a first endpoint located in the system;
a second endpoint located in the system; and
a processor to provide a trusted tunnel between communications modules within the platform.

19. The system of claim 18, the first endpoint further comprising a smart card and the second endpoint further comprising a wireless local area network card.

20. The system of claim 18, the processor further to monitor exchange of authentications between the first and second endpoints prior to establishing the trusted tunnel.

21. The system of claim 18, the trusted tunnel is based on the Transport Layer Security definitions.

22. The system of claim 18, the trusted tunnel is based on the Secure Sockets Layer definitions.

23. The system of claim 18, the processor to reside on the first endpoint.

24. The system of claim 18, the processor to reside on the second endpoint.

25. The system of claim 18, the processor to be located in the system but not on either the first or second endpoint.

26. The system of claim 18, the processor to reside at a location selected form the group comprised of: the first endpoint, the second endpoint, and outside of the endpoints.

27. An article of machine-readable media containing instructions that, when executed, cause the machine to:
receive an initiation message;
negotiate a ciphersuite across the local link;
transmit a server authentication credentials;
receive a client authentication credentials;
validate the client authentication credentials;
generate an encryption key based upon the negotiated ciphersuite; and
encrypt any further communications across the local link using the encryption key.

28. The article of claim 27, the instructions causing the machine to receive a client authentication further causes the machine to receive a ciphersuite information containing an encryption algorithm and cryptographic key types.
